(19) United States
(12) Patent Application Publication
(10) Pub. No.: US 2026/0073012 A1
(43) Pub. Date: Mar. 12, 2026

(54) ORTHOGONALIZATION-DRIVEN AND ARCHITECTURALLY COMPREHENSIVE METHODOLOGY FOR SIGNAL PROCESSING

(71) Applicant: International Technology Consultants Limited, Hong Kong (HK)

(72) Inventor: Man-fung YUEN, Hong Kong (HK)

(73) Assignee: International Technology Consultants Limited, Hong Kong (HK)

(21) Appl. No.: 18/882,861

(22) Filed: Sep. 12, 2024

(51) Int. Cl. G06F 17/16

(52) U.S. Cl. CPC G06F 17/16

(57) ABSTRACT

Disclosed is a novel orthogonalization-driven and architecturally comprehensive methodology, including computer-implemented methods and modular architectures, that can significantly enhance processing parallelism and reduce processing latency for a wide spectrum of computationally intensive signal processing tasks. This methodology also plays a crucial role in the design of high-performance integrated circuit chips for these tasks. Developing the overall methodology requires using an unique N-inputs-with-2N-outputs processing structure as the baseline architecture.

### FIELD OF THE INVENTION

This invention disclosure relates to the field of signal processing. It presents a novel orthogonalization-driven and architecturally comprehensive methodology that can significantly enhance processing parallelism and reduce processing latency for a wide spectrum of computationally intensive signal processing tasks. This methodology also plays a crucial role in the design of high-performance integrated circuit chips for these tasks.

### BACKGROUND OF THE INVENTION

Technologies for Machine Learning, Signal Processing, Wireless Telecommunication, and semiconductor integrated circuit design, such as orthogonalization networks and systolic array implementations, have been developed. Many of these technological advancements, in essence, are the results of applying fundamental mathematical principles at the foundational solution layer. One particularly critical mathematical concept involves transforming a set of N linearly independent input vectors into a set of N mutually orthogonal output vectors. This fundamental concept, together with other mathematical tools developed based on this foundation, have been used to solve for a wide range of scientific and engineering problems for more than a century. On the other hand, these mathematical principles and tools were well-established and popularized even before the start of the computer age many decades ago. Naturally, the intrinsic characteristics of these mostly century-old concepts and algorithms may not be compatible with the latest technological trends of maximizing processing parallelism and reducing processing latency. Given the above background, this invention disclosure describes a novel orthogonalization-driven methodology for the development of more efficient parallel processing architectures compared to existing techniques and approaches for a wide spectrum of signal and data processing problems.

### SUMMARY OF THE INVENTION

An object of the present disclosure is to provide a method and a system for processing input signal vectors based on an orthogonalization-driven and architecturally comprehensive methodology. Using a two-inputs-with-two-outputs building block unit known as Symmetric Orthogonalization Cell, i.e., SOC, a new generation of parallel processing architecture solutions can be developed for a wide range of signal processing scenarios and applications. The whole innovation process is described through the illustration of modular processing architecture diagrams with the associated data flow. This invention disclosure unambiguously describes the processing architecture and technology level associated with the prior art. It also provides background information on relevant signal processing application areas. Furthermore, specific breakthroughs and innovations of this invention disclosure can be summarized as follows:
1) Using the two-inputs-with-two-outputs SOC building block unit and the resulting N-inputs-with-two-outputs baseline triangular architecture, a one-dimensional processing line-array architecture is developed using an architecturally-condensing process by taking advantage of certain common signal processing application scenarios involving the overlapping of adjacent input data windows;
2) Based on the N-inputs-with-two-outputs baseline triangular architecture, an N-inputs-with-2N-outputs architecture, which can be visualized as a hollow 3-D cylindrical structure, is invented. Besides the fact that this N-inputs-with-2N-outputs concept is not mentioned at all in the prior art, a technique of concisely identifying and locating the resulting sets of mutually orthogonal q-vectors within the architecture is developed. From a practical engineering standpoint, a q-vectors identification and tracking system must be available for any QR-Decomposition-driven signal processing system;
3) Besides the novel N-inputs-with-2N-outputs architecture, another key innovation of this invention disclosure is establishing a multi-cylindrical parallel processing architecture that can exploit all the computational symmetry characteristics associated with all possible permutations out of a given set of input data vectors. This in turn provides an analytical and architectural framework for tackling a whole spectrum of next generation signal processing scenarios in a most architecturally efficient manner possible;
4) The above-mentioned cylindrical and multi-cylindrical architectures are for proper geometrical articulation and effective visualization. In terms of mapping these architectural ideas and description into actual hardware or integrated circuit chip design, well-defined ideas of rolling up a “processor sheet” containing two-dimensional planar or one-dimensional line-array processor structures so as to significantly reduce the unused physical space associated with hollow cylindrical structures are also described in this invention architectures. This process of minimizing unused or hollow physical space would then lead to compact, latency-reduced and energy-saving chip design or hardware implementation.

The claims of this invention disclosure are therefore based on the innovations and breakthroughs summarized above.

### BRIEF DESCRIPTION OF THE DRAWINGS

The present disclosure is better understood with reference to the accompanying drawings, and a concise introduction of each drawing may make the subsequent detailed description significantly easier to follow.

FIG. 1 illustrates a schematic diagram for a Gram-Schmidt orthogonalization (GSO) building unit related to the present disclosure.

FIG. 2 illustrates a schematic diagram for a symmetric orthogonalization cell (SOC) building unit that is adopted and used for the present disclosure.

FIG. 3 illustrates a schematic diagram for a parallel processing architecture for the Modified Gram-Schmidt algorithm using the GSO building unit of FIG. 1.

FIG. 4 illustrates a schematic diagram for a processing architecture built up by using the SOC building unit of FIG. 2.

FIG. 5 illustrates a schematic diagram reflecting an indexing and data-tracking system integrated with the processing architecture of FIG. 4, showing the locations of one of the two sets of mutually orthogonal output q-vectors.

FIGS. 5A and 5B are schematic diagrams illustrating a uniquely effective way of locating q-vectors in a bottom-up manner. Specifically, FIG. 5A and FIG. 5B are inserted to further strengthen the understanding of this technique used in locating these q-vectors in FIG. 5 and FIG. 6, respectively.

FIG. 6 is the same as FIG. 5, except indicating the locations of the other set of mutually orthogonal q-vectors instead.

FIG. 7 illustrates a schematic diagram for a data-window-processing scenario involving input-data-overlapping windows that can take advantage of the methodology presented in the present disclosure.

FIG. 8 illustrates a data flow and architectural condensation diagram associated with the data-window-processing scenario of FIG. 7.

FIG. 9 illustrates a schematic diagram for an example of a processing architecture corresponding to an N-inputs-with-2N-outputs system in the present disclosure.

FIG. 10 is a schematic diagram illustrating the concept and task of deleting redundant hardware explicitly shown in the processing architecture in FIG. 9.

FIG. 11 is a schematic diagram illustrating an indexing and data-tracking system integrated with the hardware-efficient processing architecture in FIG. 10.

FIG. 12 is a schematic diagram illustrating the main ideas and steps involved in addressing the generalized problem covering the entire “permutation space” in connection with the present disclosure.

FIG. 13 illustrates a schematic diagram for a hardware implementation scheme of the processing architecture in FIG. 11.

FIG. 14 illustrates a schematic diagram for presenting an innovation reflecting another efficient hardware implementation scheme in the present disclosure.

FIG. 15 illustrates a schematic diagram for a signal processing system that can be applied in the present disclosure.

FIG. 16 illustrates a schematic diagram depicting a flowchart implementing computer-implemented methods for processing signals in the present disclosure.

### DETAILED DESCRIPTION OF PREFERRED EMBODIMENTS

To make the above and other objects, features, and advantages of the present disclosure more apparent and understandable, preferred embodiments of the present disclosure are described below, along with the accompanying drawings. To establish a clear sense of continuity as well as objectively describe the original innovations, the following detailed description involves four distinct and interrelated sections: I. Original Innovations Relative to the Prior Art; II. Coupling with Key Mathematical Principles and Tools; III. Practical Application Areas; IV. Detailed Description of Processing-Parallelism-Driven Innovations.

### I. Original Innovations Relative to the Prior Art:

In a related art, an N-inputs-with-N-outputs orthogonalization algorithm and its systolic array implementation are presented. This N-inputs-with-N-outputs processing architecture developed using a two-inputs-with-two-outputs building unit is compared to another N-inputs-with-N-outputs processing architecture for the Modified Gram-Schmidt (MGS) algorithm which is built up using a two-inputs-with-one-output building unit instead. Key competitive advantages of the N-inputs-with-N-outputs architecture developed using the two-inputs-with-two-outputs building unit relative to the MGS-based architecture are: 1) data broadcasting lines are not required, and 2) any given processing node in the processing architecture only needs to communicate with its neighboring nodes. To the best of our knowledge, this related art unambiguously represents the prior art of this present invention disclosure which discloses novel architectural and computational breakthroughs relative to this prior art.

Specifically, the ultimate computational challenge of efficiently processing all possible permutations associated with a given set of input data vectors is NOT addressed in the prior art. This computational challenge in the field of signal processing is particularly relevant to the development of 6G technology and multiple-input-multiple-output (i.e., MIMO) systems in wireless telecommunication. Hence processing some or all of these possible permutations in parallel using a scalable and modular processing architecture represents a major opportunity of new technology development. To address this computational challenge associated with this “permutations space”, it is shown in this invention disclosure that starting with an N-inputs-with-2N-outputs processing architecture as the foundational solution (instead of the N-inputs-with-N-outputs architecture of the prior art) is necessary. In other words, the N-inputs-with-N-outputs architecture of the prior art cannot address or process every possible permutation of a given set of input vectors.

The linkage between this invention disclosure and key mathematical principles from Linear Algebra, particularly with respect to Singular Value Decomposition (SVD) and QR Decomposition (QRD), is described in the next section. However, the direct coupling with QRD needs to be briefly stated here because there is one particularly critical issue that is not addressed at all in the prior art. It has to do with the necessity of identifying and locating mutually orthogonal output q-vectors on the processing architecture. These q-vectors are in fact the column vectors of the Q matrix in QR Decomposition. Accurately identifying the locations of these mutually orthogonal output q-vectors is a crucial task in any application scenario, and an innovative q-vectors identification and tracing technique is to be described in detail in Section IV.

To summarize the original innovations of the present invention disclosure at the macro level relative to the prior art, they include: 1) the idea of utilizing an N-inputs-with-2N-outputs processing architecture as the foundation for various increasingly sophisticated parallel processing solutions, instead of the N-inputs-with-N-outputs architecture exclusively used in the prior art, 2) a multi-cylindrical architecture is developed for the generalized solution of simultaneously processing all possible permutations associated with a given set of input data vectors, and 3) a novel “zigzagging” technique of accurately identifying the locations of mutually orthogonal q-vectors throughout a given N-inputs-with-2N-outputs architecture.

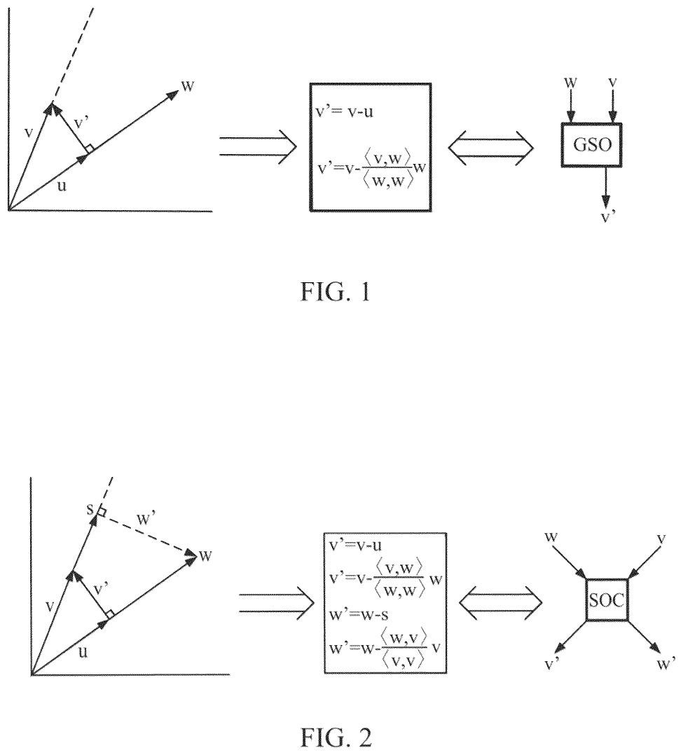

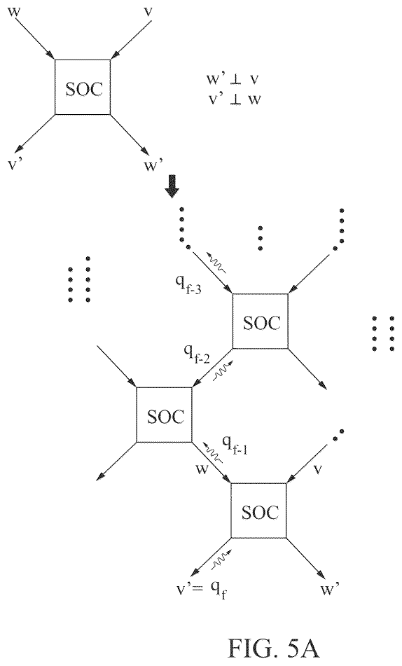

In terms of defining the boundary between the prior art and the original innovations associated with this invention among all the figures and diagrams attached to this disclosure, it is as follows: The basic ideas illustrated in FIGS. 1 to 4 represent the key ideas and foundation established by the prior art. On the other hand, original contributions and innovations associated with this invention that are beyond the prior art are expressed through the illustrations of FIGS. 5 to 14.

II. Coupling with Relevant Mathematical Principles and Tools

In the fields of Signal Processing, Machine Learning, Wireless Telecommunication and so on, two particularly useful and popular mathematical tools for research and development are Singular Value Decomposition (SVD) and QR Decomposition (QRD). To establish a sense of clarity and continuity, the basic mathematical definitions of SVD and QRD, as well as their general development histories and interrelationship that are relevant to the innovations associated with this invention disclosure, are briefly provided in the following.

SVD is considered a highlight of Linear Algebra because it is a powerful tool for addressing a wide range of purely mathematical tasks as well as application-specific problems. One of the key reasons that SVD is so useful is that it offers a way to decompose any data matrix into three simpler, more easily interpretable matrices:

$$A = U \sum {V}^{*} ,$$

wherein U is an m by m unitary matrix, Σ is an m by n diagonal matrix, V is an n by n unitary matrix, and * is a superscript representing the conjugate transpose operation. The monumental importance of SVD and its impacts on applied mathematics and the engineering world are universally recognized. An article reflecting this universal recognition can be found from a paper such as “On the Early History of the Singular Value Decomposition.” It states the contributions of five different mathematicians who had lived from the early 19th Century to the mid 20th Century for SVD's existence.

Despite its critical importance, it was not until the 1960s that SVD gained significant attention in the scientific and engineering community. SVD is especially popular in Signal Processing and Machine learning over the past few decades as it explicitly enables the tasks of dimensionality reduction, feature extraction, data compression, noise reduction, pattern recognition, etc. In Wireless Telecommunication and research efforts in relation to future “sixth generation (6G)” capabilities, SVD also plays a crucial role in multiple-input-multiple-out (MIMO) systems for improving communication channel capacity, signal quality and signal detection.

QRD, on the other hand, is a decomposition of a matrix A into a product A=QR of an orthonormal matrix Q and an upper triangular matrix R. Generally speaking, QRD can be used to tackle the same diverse set of problems in mathematics and engineering. However, unlike SVD, a single QRD by itself does not explicitly calculate eigenvectors and eigenvalues.

Notably, SVD always exists for any sort of rectangular or square matrix, whereas the Eigen Decomposition can only exist for square matrices, and even among square matrices sometimes Eigen Decomposition doesn't exist. It suffices to say that for practical applications, obtaining eigenvalues and eigenvectors using SVD is typically advised.

It is noted that the “QR algorithm”, developed by John Francis in the late 1950s, provides a bridge between QRD and the computation of eigenvectors and eigenvalues. This “QR algorithm” is an iterative method that repeatedly applies the QRD to transform a given matrix until it converges to the desired eigenvalues. In essence, this “QR algorithm” has revolutionized the computation of eigenvalues and eigenvectors, representing an important milestone in Numerical Linear Algebra. From a historical perspective, SVD and QRD are independently developed Linear Algebra tools. Nevertheless, it is emphasized that the “QR algorithm” serves as a crucial bridge between the two.

QRD has been widely used, with various specific algorithms developed to produce the “Q” and “R” matrices. The so-called “Classical Gram-Schmidt (CGS)” algorithm is generally recognized as the first method of carrying out QRD. It is well recognized that CGS suffers from numerical instability and is not suitable for large matrices in general. The Householder Transformation, introduced by Alston Householder, improved upon the CGS algorithm by providing a more stable and efficient approach. The Givens' Rotation, developed by Wallace Givens, is another method that offers numerical stability and is particularly useful for sparse matrices. Lastly, in an important experimental paper, John R. Rice discussed about the theory and error analysis in connection with an algorithm known as Modified Gram-Schmidt (MGS).

It is noted that both SVD and QRD have their “reduced” forms, corresponding to having the sigma (Σ) matrix being a square and diagonal matrix in the SVD, and the Q matrix in the QRD not being square. These “reduced” versions are used to more efficiently address or accommodate many practical application scenarios. Another common situation in many application scenarios is that the Q matrix may not need to be “orthonormal,” i.e., the “q” column vectors of Q are simply mutually orthogonal vectors and do not need to be normalized, which is the assumption for all the illustrative figures throughout the present disclosure.

The above represents a concise description of the coupling between SVD and QRD, as well as a brief history of the most recognized QRD algorithms. MGS, Householder Transformation, and Givens' Rotation still represent an active area of research, including works on their various adjusted versions, individual unique strengths for certain applications and specific processing scenarios, as well as their mathematical interrelationship. After several decades of analyses and comparison studies done on aspects related to computational parallelism, ease of hardware implementation and so on, the MGS algorithm has perhaps become the most popular approach and been widely adopted across many fields and application areas. This is evident by various MGS hardware implementation related patents filed over the past two decades or so.

To be historically accurate, the original basic concept of Gram-Schmidt was already formulated during the late 19^{th} century, whereas the Modified Gram-Schmidt algorithm was formally published in 1966. Mathematically speaking, the MGS algorithm has essentially been the standard way of computing a set of N mutually orthogonal output vectors based on a set of N linearly independent input vectors since it was published. It is important to re-state here that computing a set of mutually orthogonal output q-vectors and establishing a “foundational solution” essentially refer to the same task. In the present disclosure, the important point about the equivalence between establishing the “foundational solution” and computing a set of mutually orthogonal output q-vectors is so crucial and can not be overstated. It is also helpful to look at the mechanism of obtaining “Q” being the key focus of QRD, with the “R” matrix being a natural by-product, at least in the context of the MGS algorithm. Given the above history and reasons, the point about the critical importance of developing a new technique of accurately identifying and locating these mutually orthogonal q-vectors in the novel N-inputs-with-2N-outputs architecture associated with this invention disclosure is especially relevant. Again, no technique regarding identifying the locations of these mutually orthogonal on the novel N-inputs-with-2N-outputs architecture is mentioned in the prior art.

At the macro level, and relevant to the mathematics development milestones briefly introduced above, it suffices to state that computing a set of mutually orthogonal output q-vectors based on a set of N linearly independent input vectors represents a key and necessary computational task for a whole spectrum of scientific or engineering problems. Given this fact and continuing trend, this invention disclosure discloses a novel methodology of re-organizing this computational task by applying and leveraging novel parallel processing architecture ideas so as to significantly improve processing parallelism and reduce processing latency for many advanced signal processing applications. Some of these signal processing scenarios and applications are briefly described in the context of parallel processing in the next section. The next section focuses on the linkage between sophisticated signal processing scenarios and the N-inputs-with-2N-outputs processing architecture concept, which is the central architectural theme of this invention disclosure.

### III. Practical Application Areas:

Given the multi-disciplinary nature and diversity of potential applications associated with this invention disclosure, it would be useful to briefly explain the background of the basic N-inputs-with-N-outputs idea and the novel N-inputs-with-2N-outputs architectural arrangement repeatedly stated previously. Turning these innovations to benefits and enhanced competitiveness in the context of hardware implementation is another important theme of the present disclosure. In particular, issues such as physical compactness and processing latency in connection with integrated circuit chip design are explained in the final detailed description of Section IV.

For a diverse set of filtering and signal processing situations, there may be as many output channels as there are input channels. One relatively simple and easy-to-visualize application scenario is adaptive pulse doppler processing in radar signal processing, in which each particular doppler channel (after the Fast Fourier Transform (FFT) operation) can be processed further using the rest of the remaining doppler channels as auxiliary or supporting channels for signal enhancement and interference suppression. From this example, the basic motivation of processing EACH one of the N input channels using the remaining N−1 input channels as interference-suppression-supporting channels, resulting in the need of deploying an N-inputs-with-N-outputs processing architecture, is therefore clearly understood.

There are similar N-inputs-with-N-outputs signal processing situations across various fields. For stance, in biomedical engineering, in order to study information processing in the brain, one approach is to examine and monitor the naturally occurring magnetic fields of the brain. Measurements of these fields are known as magnetoencephalograms (MEGs) and they are obtained non-invasively near the skull surface. It is a difficult task because neuromagnetic fields are very weak. Multi-sensor systems are currently available for neuromagnetic work. These sensors are placed at different locations on the outside of the skull. Since the individual sensor noise can be modeled as additive noise that is uncorrelated from sensor to sensor, any measurement component correlated from sensor to sensor corresponds to a neuromagnetic signal. Consequently, the basic N-inputs-with-N-outputs idea together with the corresponding parallel signal processing architecture as shown in the prior art also serves as a signal enhancement technique.

The above two N-inputs-with-N-outputs signal processing examples paint a helpful picture at the application level. Although this basic N-inputs-with-N-outputs architecture idea at the application level is relatively easy to understand, the deeper idea and the ultimate goal of applying the N-inputs-with-2N-outputs architecture concept can only be understood in the context of developing a generalized solution for the entire “permutations space.” As stated previously, processing some or all possible permutations of a given set of input vectors in parallel using a modular and scalable architecture represents the focal point of this invention disclosure. And this can be achieved only through the application of the novel N-inputs-with-2N-outputs processing architecture presented in this invention disclosure.

In essence, the above two application examples, together with the coupling between the N-inputs-with-2N-outputs architectural concept and developing a comprehensive solution for the “permutations space”, are provided to enhance the understanding of the interrelationship between practical applications, applied mathematics, and the orthogonalization-driven methodology described in the present disclosure. Again, the concept of processing in parallel all possible permutations out of a set of input vectors is not touched on in the prior art, nor the idea of using the N-inputs-with-2N-outputs architecture. As illustrated in Section IV. this N-inputs-with-2N-outputs idea would then lead to the novel multi-cylindrical architecture solution for the above-mentioned “permutations space.”

### IV. Detailed Description of Processing-Parallelism-Driven Innovations

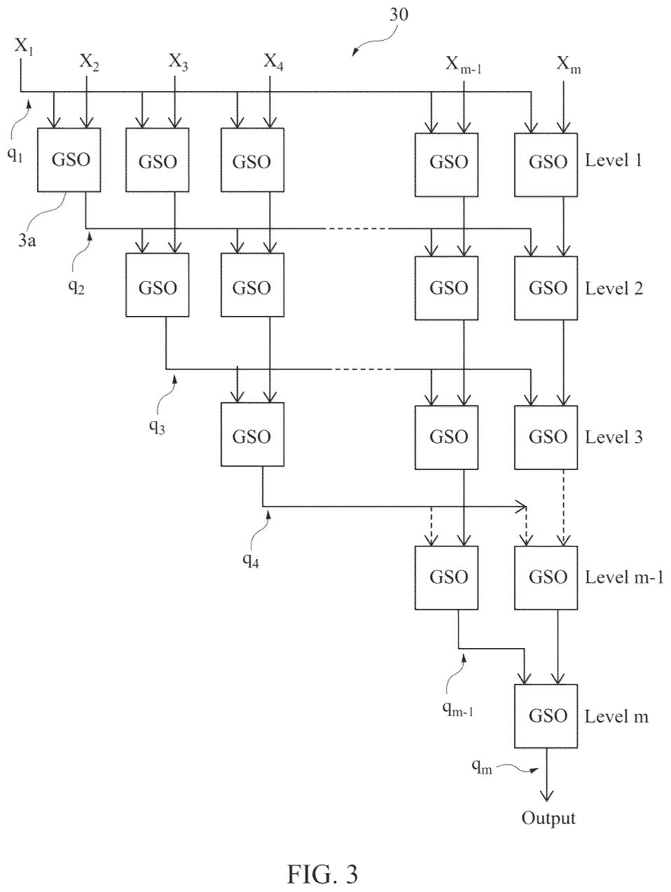

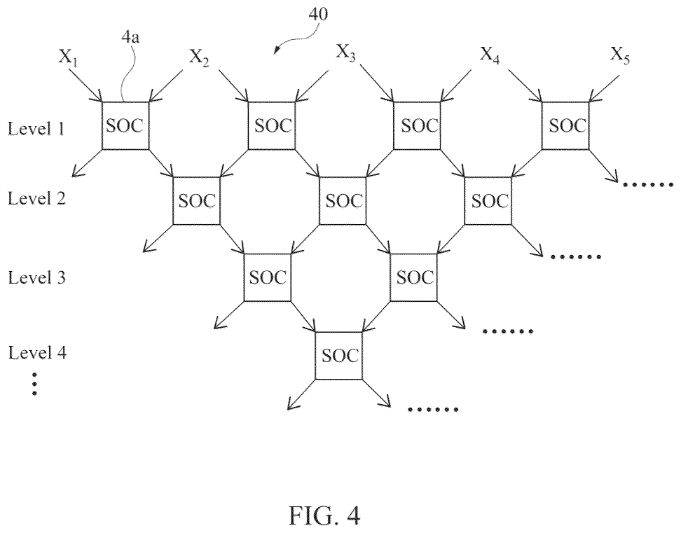

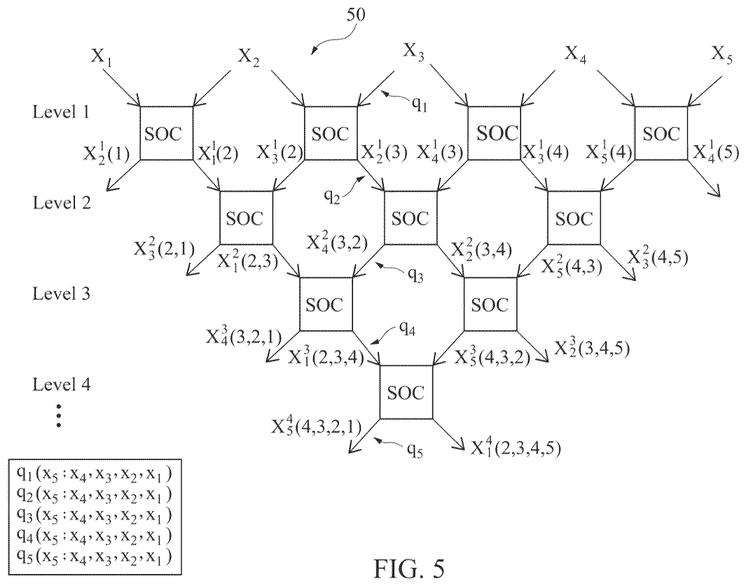

The innovations and improvement ideas presented in the present disclosure are explained mainly relative to the MGS algorithm, especially within the context of MGS's basic processing architecture of FIG. 3. FIG. 3 shows a parallel processing architecture 30 for the Modified Gram-Schmidt (MGS) algorithm, with the set of mutually orthogonal output q-vectors computed shown as q₁, q₂, q₃, q₄, . . . , qₘ₋₁, and qₘ which are individually located at each orthogonalization level at the diagonal positions. The input vectors/channels in FIG. 3 are expressed as Xᵢ (i.e., X₁, X₂, X₃, X₄, . . . , Xₘ₋₁, and Xₘ) and the building units are expressed as GSO processing cells 3a. The GSO building unit for the MGS architecture and the SOC building unit for the N-inputs-with-two-outputs example architecture of FIG. 4 are illustrated in FIG. 1 and FIG. 2, respectively. For the SOC building unit, achieving computational symmetry, hence resulting in computational saving, is simply due to the definition of inner product in Linear Algebra. The two-inputs-with-two-outputs SOC building unit of FIG. 2 can therefore take advantage of such computational symmetry. Given this fact, all subsequent explanations and descriptions in the rest of the present disclosure can be easily understood just by following the movements of all the input vectors, as well as both intermediate and final output vectors, within a given processing architecture. After all, each movement or transfer of every input or output vector is done within a modular, scalable and perfectly regular processing architecture. In other words, the flow and movements of all the input and output vectors are, architecturally speaking, self-explanatory and easy to follow, and therefore require no explicit mathematical descriptions. In fact, if a purely mathematical description is used for all the movements and flow of vectors, it would be exceedingly complicated and practically useless for the purpose of articulating the details of the whole invention. This point about practical usefulness is particularly relevant when it comes to implementation in hardware. Besides the lack of computational symmetry associated with the MGS building unit of FIG. 1, the input data broadcasting line across each level of orthogonalization of the MGS architecture of FIG. 3 can also have negative impacts on the facilitation of parallel processing for complex signal processing scenarios. Notably, this point will become increasingly clearer in the subsequent illustrations. FIG. 4 represents an architecture 40 built up by using a plurality of SOC building blocks 4a that are mentioned above. Although this basic N-inputs-with-two-outputs example structure is described in the prior art, the locations of the corresponding two sets of mutually orthogonal output q-vectors produced within the processing architecture are not mentioned at all in the prior art. This particular missing piece of information in the prior art can therefore be viewed as an innovation opportunity for this invention disclosure. Simply put, the orthogonalization-driven architecture shown in FIG. 4 with enhanced parallel processing and computational symmetry characteristics can naturally be used to replace the basic MGS architecture of FIG. 3. There are actually two final output channels in FIG. 4 instead of the single final output channel shown in the basic MGS architecture in FIG. 3. Five input vectors/channels of Xᵢ (i.e., X₁, X₂, X₃, X₄, and X₅) and the SOC building units 4a arranged in four different levels (i.e., Level 1 to 4) are used for the illustration example of FIG. 4.

FIGS. 1 to 4 present the key background information. These background information, together with the basic N-inputs-with-N-outputs architectural concept, are also contained in the prior art. However, it must be re-stated that the task of accurately locating the resulting mutually orthogonal output q-vectors for the N-inputs-with-two-outputs architecture, as well as for its extended N-inputs-with-N-outputs version, in the prior art is NOT addressed at all. Using Linear Algebra language, this particular task, which, again, is missing in the prior art, corresponds to the necessity of computing and identifying the resulting mutually orthogonal column vectors of the Q matrix in connection with QR Decomposition. To re-state the three specific drawbacks and unresolved issues associated with the prior art relative to the present disclosure, they are: (1) the missing of the above-mentioned identification task of locating mutually orthogonal output q-vectors in the processing architecture, (2) the idea of utilizing the basic N-inputs-with-2N-outputs processing architecture is not considered at all, and (3) the prior art also does not address the challenge of simultaneously processing all possible permutations associated with a given set of input data vectors. Given this background, all the diagrams and their contents beyond FIG. 4 in the present disclosure represent new ideas and original innovations.

Due to the importance of accurately locating the resulting mutually orthogonal output q-vectors, the basic architectural concept of FIG. 4 is re-shown as FIG. 5 to include these q-vector locations. In addition, an indexing system for identifying and tracing every possible vector entity represented as Xⱼⁱ(m, n, o, . . . ) is developed and inserted in FIG. 5 as well. FIG. 5 illustrates an example 50 indicating a particular set of mutually orthogonal q-vectors, which is linked with one of the two final output vectors. The example of FIG. 5 contains the following indices and information: an index indicating a particular level of orthogonalization in the architecture; an index specifying the position information of a given output vector after certain number of levels of sequential orthogonalization steps; a sequence of indices specifying the exact ordering of a set of orthogonalization steps that has already been carried out; and the exact positions of the resulting mutually orthogonal q-vectors, i.e., qᵢ(x₅; x₄, x₃, x₂, x₁), wherein i=1 to 5 in this case. The index of subscript “i” of qᵢ(x₅; x₄, x₃, x₂, x₁) in this case refers to a particular vector among a given set of mutually orthogonal q-vectors, with the first index within the parenthesis referring to the “input channel to be processed”, i.e., the main input channel of focus. Notably, although the rest of the indices within the same parenthesis may seem to be just a natural way of listing the rest of the input channels, the ordering of these remaining input channels is crucial. Hence the indexing sequence within the parenthesis actually also specifies a particular permutation among all possible permutations associated with a given set of input channel vectors. In other words, x₅ in this particular case refers to the “input channel to be processed”, together with the ordered sequence of orthogonalization steps indicated as x₄, x₃, x₂, x₁ within the parenthesis. Therefore all the indices plus the ordered sequence within the parenthesis represent the particular permutation of {5, 4, 3, 2, 1} in this particular example. Also, using the indexing system adopted here, q₅(x₅; x₄, x₃, x₂, x₁) is the same vector as

$${X}_{5}^{4} ( 4 , 3 , 2 , 1 )$$

### in FIG. 5.

For completeness and to establish a clear picture as well as an easy-to-follow pattern, the five mutually orthogonal q-vectors in this particular case of treating the input channel X₅ as the “input channel to be processed” in FIG. 5 are as follows:

$${q}_{5} ( {x}_{5} ; {x}_{4} , {x}_{3} , {x}_{2} , {x}_{1} ) = {X}_{5}^{4} ( 4 , 3 , 2 , 1 )$$

$${q}_{4} ( {x}_{5} ; {x}_{4} , {x}_{3} , {x}_{2} , {x}_{1} ) = {X}_{1}^{3} ( 2 , 3 , 4 )$$

$${q}_{3} ( {x}_{5} ; {x}_{4} , {x}_{3} , {x}_{2} , {x}_{1} ) = {X}_{4}^{2} ( 3 , 2 )$$

$${q}_{2} ( {x}_{5} ; {x}_{4} , {x}_{3} , {x}_{2} , {x}_{1} ) = {X}_{2}^{1} ( 3 )$$

$${q}_{1} ( {x}_{5} ; {x}_{4} , {x}_{3} , {x}_{2} , {x}_{1} ) = {X}_{3}$$

The above positions/locations of the resulting set of mutually orthogonal q-vectors within the architecture are identified in accordance with the fundamental principle that each of the two outputs associated with any given SOC building unit as illustrated in FIG. 2 is orthogonal to one of the two input vectors to the same building unit. Based on this simple principle and recognizing the zigzagging pattern involved, one can logically and easily locate these mutually orthogonal q-vectors as shown in FIG. 5.

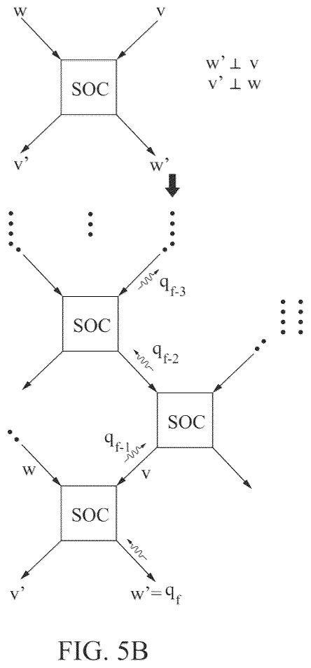

FIG. 6 illustrates another example 60 that is essentially the same as FIG. 5, except that for completeness the locations of the other set of mutually orthogonal q-vectors are shown instead. This is to re-confirm on the practicality and usefulness of applying the “zigzagging” technique to track down the locations of mutually orthogonal q-vectors. Again, FIG. 6 is provided to show the positions/locations of the set of mutually orthogonal output vectors associated with the other final output vector, i.e.,

$${X}_{1}^{4} ( 2 , 3 , 4 , 5 ) .$$

It is noted that the convention and indexing system adopted here is that this so-called “final output vector” also corresponds to the last vector of a given set of mutually orthogonal output vectors. To elaborate,

$${X}_{1}^{4} ( 2 , 3 , 4 , 5 )$$

could be understood as the result of processing the first input channel vector, i.e., X₁ in this case, in accordance with the ordered orthogonalization sequence of (2, 3, 4, 5), which in turn corresponds to the particular permutation of input vectors of {1, 2, 3, 4, 5}. There is a little bit of overlap in expressing all the necessary information and indices for different vector entities across the architecture. This is meant to ensure consistency and to enable programmable cross-checking in any software development environment. Consistent with the above-mentioned clarification and the zigzagging vectors-locating method, the set of mutually orthogonal q-vectors associated with the final output vector of

$${X}_{1}^{4} ( 2 , 3 , 4 , 5 )$$

is as follows:

$${q}_{5} ( {x}_{1} ; {x}_{2} , {x}_{3} , {x}_{4} , {x}_{5} ) = {X}_{1}^{4} ( 2 , 3 , 4 , 5 )$$

$${q}_{4} ( {x}_{1} ; {x}_{2} , {x}_{3} , {x}_{4} , {x}_{5} ) = {X}_{5}^{3} ( 4 , 3 , 2 )$$

$${q}_{3} ( {x}_{1} ; {x}_{2} , {x}_{3} , {x}_{4} , {x}_{5} ) = {X}_{2}^{2} ( 3 , 4 )$$

$${q}_{2} ( {x}_{1} ; {x}_{2} , {x}_{3} , {x}_{4} , {x}_{5} ) = {X}_{4}^{1} ( 3 )$$

$${q}_{1} ( {x}_{1} ; {x}_{2} , {x}_{3} , {x}_{4} , {x}_{5} ) = {X}_{3}$$

The above indexing system shown in FIG. 5 and FIG. 6 for identifying and locating mutually orthogonal q-vectors may seem to be somewhat complex with all the indices involved. However, the whole indexing system is in fact very structured. And the basic orthogonality principle used in locating these mutually orthogonal q-vectors in a zigzagging manner can be easily understood. To further clarify the above facts, the basic orthogonality principle and the zigzagging pattern involved are re-illustrated in a stand-alone manner in FIG. 5A and FIG. 5B as follows:

We first start with the fact that one of the two final output vectors in FIG. 4 should be understood as the last-and-final q-vector for the corresponding set of mutually orthogonal q-vectors. It is designated as q_{f} in the illustration of FIG. 5A. As shown in FIG. 5A, v′ (=q_{f}) in this case represents the last-and-final q-vector, i.e., q_{f} at the bottom of the processing architecture.

The orthogonality feature of the building unit (SOC) can then be applied, i.e., the right-hand-side output vector is orthogonal to the right-hand-side input vector. Hence the previous q-vector before the final q-vector of g_{f}, which is designated as q_{f-1} as illustrated in FIG. 5A, can be architecturally located as well as determined in a mathematically logical manner. The zigzagging pattern of identifying and locating the remaining q-vectors of q_{f-1}, q_{f-2}, q_{f-3}, . . . , q₁, carried out in a bottom-up manner, can therefore be clearly understood and verified.

For completeness, FIG. 5B illustrates the same zigzagging pattern of identifying and locating a particular set of q-vectors, starting with the other one of the two final output vectors in FIG. 4. As shown in FIG. 5B, w′ (=q_{f}) in the case represents the last-and-final q-vector, i.e., q_{f} at the bottom of the processing architecture.

To the best of our knowledge, the above critically-needed and practical method of locating a given set of mutually orthogonal q-vectors in a parallel processing architecture is not mentioned in the prior art, nor in any public domain articles associated with signal processing or parallel processing architecture.

It is noted again that besides the fact that the identification of mutually orthogonal q-vectors is missing in the prior art, another important aspect regarding the prior art is that it basically focuses exclusively on the comparison in terms of architectural compactness between a MGS-based architecture built up using the building unit shown in FIG. 1 versus an architecture built up using the building unit shown in FIG. 2. The MGS-based architecture is purely an N-inputs-with-N-outputs architecture. In order to make it an apple-to-apple comparison, the architecture built up using the building unit shown in FIG. 2 in the prior art is, as expected, also an N-inputs-with-N-outputs architecture. On the other hand, the “baseline” architecture in the present invention disclosure is an N-inputs-with-2N-outputs architecture.

To repeat the same crucial point: In order to address any engineering problem or develop any innovative hardware implementation solution that is consistent with the QR decomposition principle, it is necessary to clearly identify the locations of the mutually orthogonal q-vectors of the Q matrix in the processing architecture. In other words, identifying and extracting these q-vectors in the architecture must be done before any appropriate computations for a given signal processing application scenario can be carried out. Hence the method of identifying and extracting these q-vectors offered by the present disclosure, as illustrated in FIGS. 5 and 6 as well as in FIG. 5A and FIG. 5B, represents an important and original innovation when compared to the prior art.

Another point that should be emphasized is that the vectors-locating method as used in FIGS. 5 and 6 is independent of the number of input channels involved. As long as the bottom-up zigzagging tracing path is followed, the correct locations of the resulting set of mutually orthogonal q-vectors can be correctly identified. With this vectors-locating method explained and illustrated above, the locations of mutually orthogonal q-vectors will therefore not need to be explicitly shown in all subsequent illustrations in the present disclosure. Notably, since the architecture of FIG. 4 with the corresponding building unit of FIG. 2 are totally different, respectively, from those associated with the MGS algorithm in FIGS. 1 and 3, the locations of their respective resulting mutually orthogonal q-vectors are, as expected, different. Regardless, it is noted that the locations of these mutually orthogonal q-vectors in the present disclosure are identified purely by examining the architecture and following the fundamental orthogonalization principle without going through any mathematical derivations.

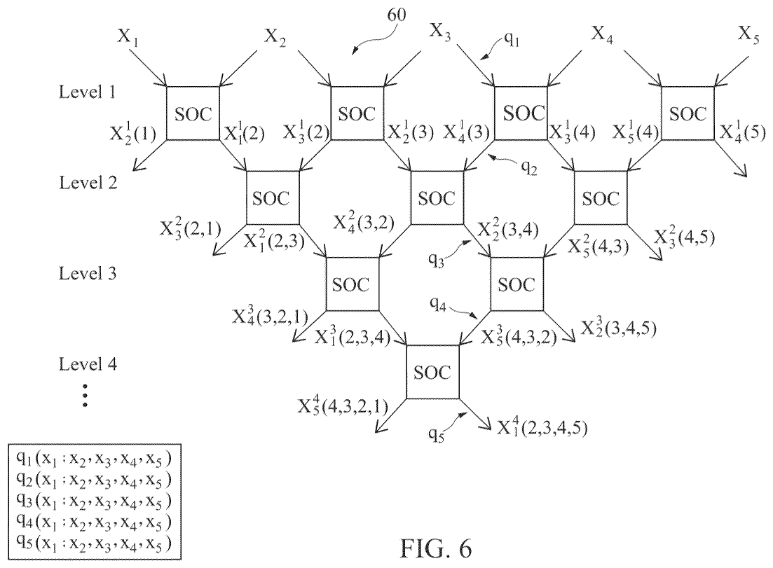

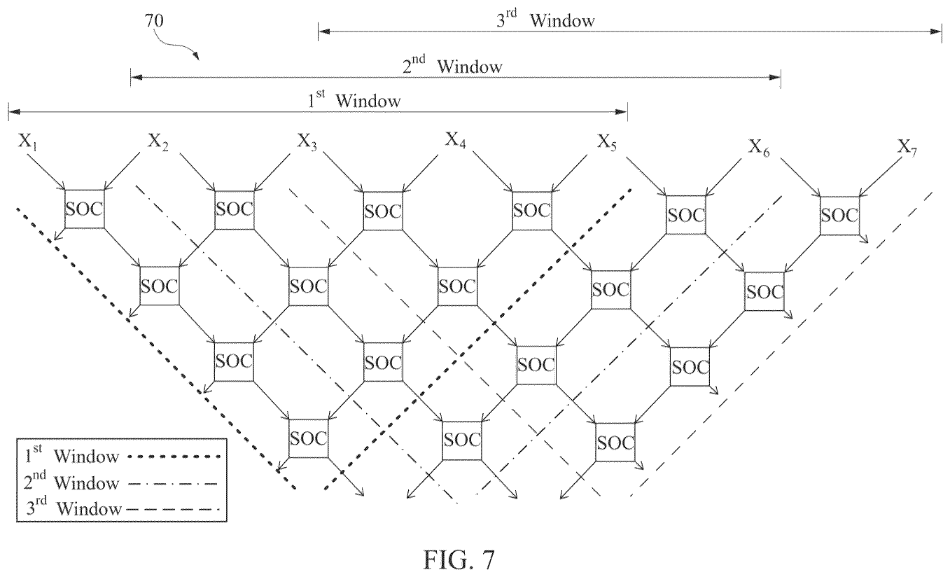

The basic architecture presented in FIG. 4 serves as a foundation to address various signal processing scenarios and situations. The key point here is that the well-entrenched MGS architecture of FIG. 3 simply can not adequately address these scenarios and situations. One such category of signal processing scenarios identified is the “window-processing” situation, which is a common application scenario involving the use of input data in a purely serial form. As an innovative contribution in the present disclosure, FIGS. 7 and 8 illustrate how the basic 2-D triangular architecture of FIG. 4 can be condensed to a 1-D line-array architecture by taking advantage of the “window-processing” input data structure. FIG. 7 shows an example 70 indicating an input-data-overlapping window structure associated with a “window-processing” scenario. In addition, in order to demonstrate the process of removing redundant hardware, unnecessary SOCs are included to better visualize the hardware-deleting idea. In addition, FIG. 7 illustrates the situation of how neighboring input data windows largely overlap with each other. Hence the term of “window-processing” is used to describe such kind of processing situation. In FIG. 7, each triangular architecture enclosed by dashed lines is shown to be directly coupled with a particular input-data-overlapping window, such as “₁ₛ Window” using SOCs to process input vectors X₁-X₅, “2^{nd} Window” using SOCs to process vectors X₂-X₆, and “3^{rd} Window” using SOCs to process vectors X₃-X₇. And the three identical and overlapping triangular architectures (i.e., the 1^{st}, 2^{nd} and 3^{rd} Windows) are grouped together in FIG. 7 so as to create the visual effect of “hardware redundancy.” In FIG. 7, each input data set or window enters into the architecture one data window at a time. Since each particular input data window greatly overlaps with the window before it and the one after it, the term of “input-data-overlapping window processing” is used. The explicit showing of “hardware-redundancy” in FIG. 7 is meant to illustrate the opportunity to remove “redundant hardware” even within one single 2-D triangular architecture. This naturally leads to the feasibility of condensing the original 2-D triangular architecture of FIG. 4 to a 1-D line-array architecture as shown in FIG. 8.

FIG. 8 shows an example 80 indicating a result of condensing or collapsing the architecture containing hardware redundancy in FIG. 7 by exploiting the above-mentioned input-data-overlapping window structure and the storage of already computed results. In FIG. 8, consecutive input data sets (i.e., data windows including the “₁ₛ Window” for vectors X₁-X₅, the “2^{nd} Window” for vectors X₂-X₆, and the “3^{rd} Window” for vectors X₃-X₇) and how they enter into the processing architecture in a “input-data-overlapping window” manner to generate the “₁ₛ Window output,” “2^{nd} Window output,” “3^{rd} Window output”, as well as the concept of storing the previously computed outputs to be used for the next input data set, are shown as a data flow picture 8D indicating data transferring to neighboring memory after each processing of a given data window. In other words, the stored results in memory associated with the previously computed input data set or window are used so as to avoid re-computing a large portion of the computations that is already done. Again, this is to take advantage of the input data structure associated with “input-data-overlapping window processing.” The processing sequence is that after the initial processing (of using the whole 2-D triangular architecture for the first input data window if needed or chosen), only one fully active computing column 8F, i.e., the diagonal processing column on the right, is used afterwards. The key point here is that the MGS architecture of FIG. 3 simply can not take advantage of this 2-D to 1-D architectural condensation feature and “input-data-overlapping window” situation. This is largely due to the lack of architectural symmetry associated with using the two-inputs-with-one-output building unit of the MGS architecture.

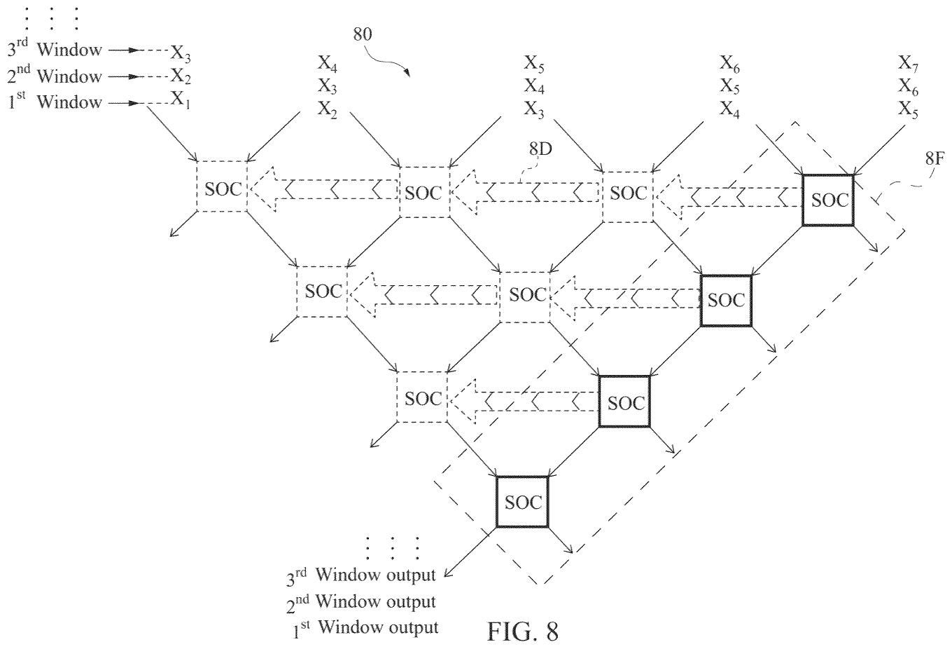

Besides the above 2-D to 1-D architectural condensation innovation for “input-data-overlapping window processing” scenarios, the basic 2-D N-inputs-with-two-outputs architecture of FIG. 4 can also be extended to address the processing of some or all of the possible permutations associated with a given set of input data vectors in parallel. This is a new challenge in signal processing. To tackle this “permutations space” in the context of parallel processing, an example involving four input vectors/channels is used for simplicity of illustration instead. In the example of FIG. 9 with 4 input channels, explicitly illustrating “hardware redundancy”, similarly done in FIG. 7, is also adopted. FIG. 9 shows an example 90 of the architectural concept of a N-inputs-with-2N-outputs system using N=4. It also includes redundant hardware so as to highlight the importance of exploiting architectural and computational symmetry and the idea of removing these unnecessary hardware building blocks. It may not be immediately obvious why the first three input vectors associated with the three input channels (i.e., X₁, X₂, and X₃ in FIG. 9) processed by three SOCs 9a in a group 9D are repeated on the top.

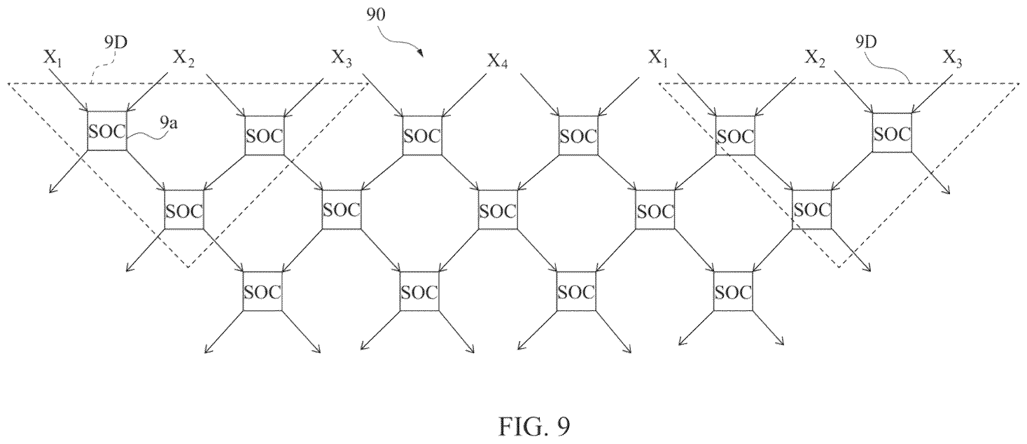

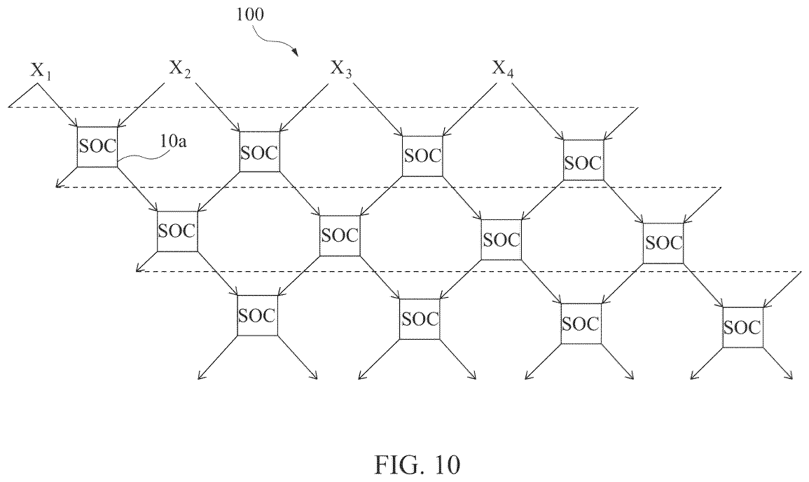

FIG. 10 illustrates an example 100 regarding the deletion of hardware redundancy contained in FIG. 9, and presents an efficient N-inputs-with-2N-outputs parallel processing architecture using SOCs 10a. Notably, it also implicitly reflects the feature of processing two permutations out of a set of input vectors simultaneously. This is a subtle but critical feature, and represents the launching point in the search of a “global optimal architecture solution” for processing all possible permutations out of a given set of input data vectors in parallel. In FIG. 10, the removal of “redundant hardware” in the present N-inputs-with-2N-outputs architecture, i.e., removing the unnecessary SOCs as explicitly drawn in FIG. 9, is illustrated. FIG. 11 is the same as FIG. 10, except the above-mentioned indexing system is also included so as to illustrate a full architectural and data flow picture. FIG. 11 shows an example 110 that inserts the above-mentioned indexing and tracking system involving all the

$${X}_{j}^{i} ( m , n , o , … )$$

entities onto the N-inputs-with-2N-outputs architecture of FIG. 10, similar to FIG. 5 for the basic N-inputs-with-two-outputs architecture.

In order to establish an effective characterization with clear notations for any given set of mutually orthogonal q-vectors, the present disclosure provides a data identification and retrieval system (DIRS) as follows.

Starting with choosing a particular final output vector out of a total of 2N available ones as the last q-vector of a given set of N mutually orthogonal q-vectors, the rest of the N−1 q-vectors can be identified and retrieved, in a bottom-up manner, by this DIRS described in the present disclosure. The notations used and data flow concepts involved are consistent with those of FIG. 11.

The entity of Xⱼⁱ (m, n, o, . . . ) is able to represent any intermediate or final output vector throughout the entire N-inputs-with-2N-outputs architecture, as shown in the four-inputs-with-eight-outputs example of FIG. 11, wherein “i” is the index representing the number of levels/steps of orthogonalization already completed, “j” is the index indicating which particular original input vector is being processed, and (m, n, o, . . . ) specifies the ordered sequence of a group of input vectors that have already gone through the orthogonalization process with respect to the j-th input vector. For simplicity as well as consistency of notations, the set of input vectors of X₁, X₂, X₃, . . . , X_{N} is adjusted as X⁰₁, X⁰₂, X⁰₃, . . . , X⁰_{N} for the purpose of including all the original input vectors in the Xⱼⁱ (m, n, o, . . . ) representation in the DIRS. In other words, adding the superscript of “0” to the original input vectors is meant to indicate that all the original input vectors have not gone through any orthogonalization step yet. Hence when i=0 the attachment of “(m, n, o, . . . )” would not be needed since no orthogonalization processing has been carried out yet.

Furthermore, two issues regarding indexing convention and notations are clarified as follows:

To re-state, there are 2N final output vectors produced from a given set of N input vectors through an N-inputs-with-2N-outputs modular processing architecture, which can be visualized as a hollow cylindrical structure. Two different final output vectors are therefore linked with each particular input vector that is being processed to be orthogonal with the rest of the N−1 input vectors. It should be noted that the key difference between the two different final output vectors of a given pair is the order of the same set of orthogonalization steps involved, i.e., one of these two final output vectors would go through a particular sequence of N−1 orthogonalization steps in one direction, while the other one of the pair would go through the same set of orthogonalization steps in the reversed order. Also, having “i” as N−1 can be visualized as having a given input vector already transformed to be a final output vector. In FIG. 11, e.g., X³₂(3,4,1) and X³₂(1,4,3) form such a pair of final output vectors that are linked with the same input vector of X⁰₂. Consequently, the superscript “i” runs as follows: 0, 1, 2, . . . , N−1. Since any such pair of final output vectors are positioned next to each other at the bottom of the architecture as can also be seen in FIG. 11, every such pair of final output vectors can be uniquely labeled as the right-hand-side one (i.e., “R”) and the left-hand-side one (i.e., “L”). This is useful for identifying and selecting a particular final output vector as a particular last q-vector of a set of N q-vectors, as well as for database design. For instance, the pair of final output vectors of X³₂(3,4,1) and X³₂(1,4,3) in FIG. 11 can be labeled and represented as X³₂(L) and X³₂(R), respectively. It should be noted that for the purpose of describing the DIRS herein, the “L” and “R” notations are used strictly for categorizing the 2N final output vectors and for identifying the last q-vector of each set of N q-vectors only. To state clearly, there are 2N sets of N q-vectors per N-inputs-with-2N-outputs architecture.

For example, as shown in FIG. 11, a method provided in the present disclosure includes step of: providing a configuration with an N-inputs-with-2N-outputs architecture, in which a plurality of building units (i.e., “SOC”) 11a are arranged in a plurality of levels (such as “Level 1,” “Level 2,” and “Level 3”), each level has N-numbered building units 11a, each building unit 11a is capable of performing a symmetric orthogonalization in association with two vectors input by two ports on two sides (such as X²₂(3,4) and X²(4, 3)) and two vectors output by two ports on two sides (such as X³¹(4, 3, 2) and X³₂(3, 4, 1)), in which two vectors input and output by two ports on the same side (such as X²₁(4, 3) and X³₂(3,4,1)) of each of the building units 11a are orthogonal, two ports on different sides of adjacent two of the building units 11a or different sides of the first and the last of the building units 11a are capable of inputting one of N-numbered vectors in the first level (e.g., “Level 1”), the N-numbered building units 11a are capable of outputting one of 2N-numbered vectors in the last level (e.g., “Level 3”), and in an upper level and a lower level adjacent between the first and last levels, two ports for outputting data on different sides of two adjacent building units 11a or different sides of the first and last building units 11a in the upper level (such as Level 1 or Level 2) are linked to two ports for inputting data on different sides of one of the building units 11a in the lower level (such as Level 2 or Level 3).

In addition, as shown in FIG. 11, the method further includes step of: retrieving a set of vectors in a linked-ports path from one port of one building unit 11a in the last level (e.g., “Level 3”) to one port of one building unit 11a in the first level (e.g., “Level 1”) in a zigzagging-from-bottom-up manner.

In FIGS. 5A and 5B, the basic “zigzagging-from-bottom-up” manner is shown using the straightforward expression of q_{N}, q_{N-1}, q_{N-2}, . . . , q₁ to list out a given sequence of N q-vectors in reverse. In order to be able to uniquely specify any particular q-vector and directly map it to the generalized expression of Xⁱⱼ (m, n, o, . . . ) used in the N-inputs-with-2N-outputs architecture example as illustrated in FIG. 11, a more detailed yet concise notation of qₛ(j, p) is adopted, wherein s is a member of the sequence of {N, N−1, N−2, . . . , 2, 1}, which means s is an index that runs in a last-to-first manner and represents the position of a q-vector in a particular set of N q-vectors; “j” indicates the index indicating both the original input vector and the corresponding pair of final output vectors; “p” can be “L” or “R” as explained above.

Once a particular final output vector with a particular “j” and a particular “p” (i.e., p is “L” or “R”, alternatively, “0” or “1”) is selected, then the corresponding last q-vector of q_{N}(j, p) is automatically determined. The retrieval process for the rest of the N−1 q-vectors for a given set is then as follows.

If p=“L”, then the bottom-up retrieval sequence of the j-index would follow the sequence of: j, j−1, j−1+2, j−1+2−3, . . . , at modulo N. In other words, e.g., if j=2 with N=4, the resulting sequence would correspond to: 2, 1, 3, 4 (since the actual counting sequence follows: 1, 2, 3, 4, 1, 2, 3, 4, 1, 2, . . . for the case of N=4). In addition, the orthogonalization sequence of (m, n, o, . . . ) would be “flipped-and-then-with-the-first-index-deleted”.

For example, in the case that the final output vector of X³₂(3,4,1) or X³₂(L) is selected, then q₄(2, L)=X³₂(3,4,1); q₃(2, L)=X²₁(4,3); q₂(2, L)=X¹³(4); q₁(2, L)=X⁰₄.

If p=“R”, then the bottom-up retrieval sequence of the j-index would follow the sequence of: j, j+1, j+1−2, j+1−2+3, . . . , at modulo N. In other words, e.g., if j=2 with N=4, the resulting sequence would correspond to: 2, 3, 1, 4 (since the actual counting sequence follows: 1, 2, 3, 4, 1, 2, 3, 4, 1, 2 . . . for the case of N=4). In addition, the orthogonalization sequence of (m, n, o . . . ) would be “flipped-and-then-with-the-first-index-deleted”.

For example, in the case that the final output vector of X³₂(1, 4, 3) or X³₂(R) is selected, then q₄(2, R)=X³₂(1, 4,3); q₃(2, R)=X²₃(4, 1); q₂(2, R)=X¹¹(4); q₁(2, R)=X⁰₄. The above represents the core framework of DIRS, as well as analytically and logically illustrates the “zigzagging-from-bottom-up” technique which is a key innovation of the present disclosure.

To further clarify the linkage between the N-inputs-with-2N-outputs type of architecture, illustrated for the case of N=4 in FIG. 11, and the goal of processing in parallel all possible permutations out of a given set of input data vectors, the following facts and patterns are provided.

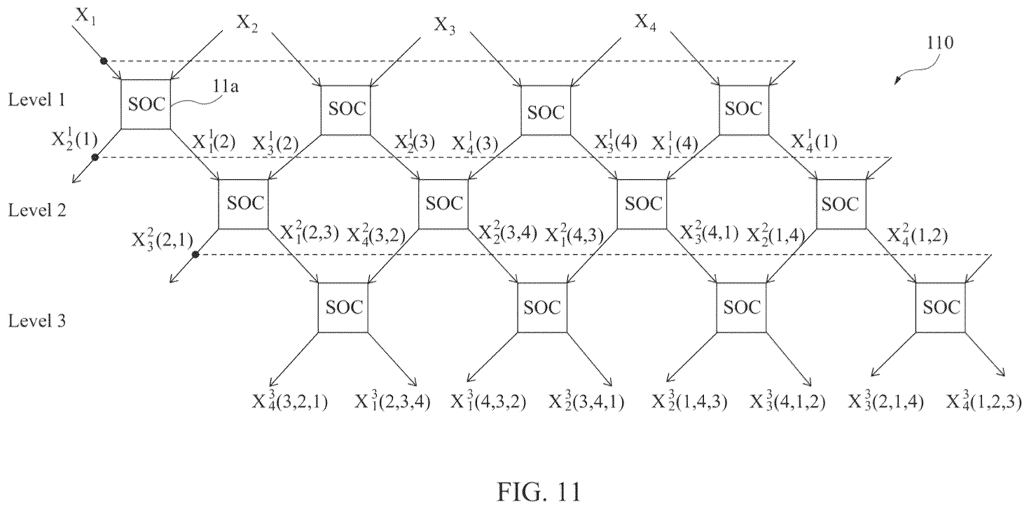

Fact No. 1: starting with the 2-D parallelogram planar architecture 12a of FIG. 12 similar to the example 110 as shown in FIG. 11 involving four input vectors/channels, a 3-D cylindrical architecture 12b with vectors Xₐ, X_{b}, X_{c}, and X_{d}, after being rolled up, to form a top view 12c of cylinder can be formed by connecting the left edge with the right edge of the architecture 12a as shown in the upper right hand corner of an example 120 of FIG. 12. For the “architecturally comprehensive” methodology described in the present disclosure, a key component is the development of a generalized parallel processing solution for every possible situation corresponding to a particular permutation of a given set of input data vectors, as illustrated in FIG. 12.

FIG. 12 indicates the main ideas and steps involved in coming up with a uniquely powerful solution to address the “permutations space.” It involves discovering and exploring the underlying computational parallelism and symmetry properties using an architecturally driven approach. For example, the number of independent cylindrical architectures to process all possible permutations out of a given set of input vectors/channels is (N−1)!/2, and this is determined by architecturally examining the computational symmetry patterns. Notably, bringing the two edges together is equivalent to shortening the lengths of the three horizontal data broadcasting lines of the parallelogram architecture of FIG. 11 to “zero”, thus forming a 3-D hollow cylindrical structure.

Fact No. 2: once in the cylindrical form, one can take a top view 12c of the processing cylinder and visualize it as a circle with four particular entry points on it, representing the four input channels to the processing cylinder in this particular example.

Fact No. 3: one can then list out all the permutations 12d. In this example involving four input vectors/channels, there are therefore 4!number of permutations 12d which is twenty-four. For example, there are 4!permutations of {a, b, c, d} in a case of four channels:
(1, 2, 3, 4) & (4, 3, 2, 1);
(1, 2, 4, 3) & (3, 4, 2, 1);
(1, 3, 2, 4) & (4, 2, 3, 1);
(1, 3, 4, 2) & (2, 4, 3, 1);
(1, 4, 2, 3) & (3, 2, 4, 1);
(1, 4, 3, 2) & (2, 3, 4, 1);
(2, 1, 3, 4) & (4, 3, 1, 2);
(1, 2, 4, 3) & (3, 4, 2, 1);
(2, 1, 3, 4) & (4, 3, 1, 2);
(2, 1, 4, 3) & (3, 4, 1, 2);
(2, 3, 1, 4) & (4, 1, 3, 2);
(2, 4, 1, 3) & (3, 1, 4, 2);
(3, 1, 2, 4) & (4, 2, 1, 3);
(3, 2, 1, 4) & (4, 1, 2, 3).

Fact No. 4: each permutation in this case is represented as a set of four ordered indices. A helpful question to ask at this point is this: Given a particular permutation that is already being processed by a given cylindrical architecture with four input vectors/channels, what other permutations can be processed in parallel by the same processing cylinder? This question naturally leads to the examination of the coupling between the N-inputs-with-2N-outputs cylindrical architecture as shown in FIG. 11, where N=4 in this case, and the group of permutations that are being processed in parallel by the same cylindrical architecture. For example, if we start with the permutation of {1,2,3,4}, then the following permutations are in fact being processed by the same cylindrical architecture in parallel due to the circularly invariant property.

For example, by looping in the forward direction starting with {1,2,3,4}, the following permutations are produced: {2,3,4,1}, {3,4,1,2}, {4,1,2,3}; by looping in the other direction, i.e., the backward direction, starting with {4,3,2,1}, then the following ones are produced: {3,2,1,4}, {2,1,4,3}, {1,4,3,2}.

Hence the above eight different permutations from a given set of four input vectors/channels are all being processed in parallel by, in this case, a four-inputs-with-eight-outputs cylindrical architecture of FIG. 11.

Similarly, looping in the forward direction starting with {1,3,2,4}: {3,2,4,1}, {2,4,1,3}, {4,1,3,2}; and then looping in the other direction starting with {4,2,3,1}: {2,3,1,4}, {3,1,4,2}, {1,4,2,3}. Finally, looping in the forward direction starting with {1,2,4,3}: {2,4,3,1}, {4,3,1,2}, {3,1,2,4}. In addition, looping in the other direction starting with {3,4,2,1}: {4,2,1,3}, {2,1,3,4}, {1,3,4,2}. Hence all twenty-four permutations in this case of having 4 input vectors/channels are accounted for.

Using the above bi-directional looping technique and concept, one can systematically determine how many independent cylindrical processing architectures are needed to process all possible permutations in parallel. FIG. 12 illustrates the process and technique based on the example involving four input vectors/channels. It also provides the analytical expression 12e of (N−1)!/2 which provides the number of independent N-inputs-with-2N-outputs cylindrical processing architectures needed to process all possible permutations associated with a given set of N input vectors/channels. In this example of N=4, the number of cylindrical architectures needed would therefore be three independent processing cylinders which is consistent with the above-mentioned visualization technique of bi-directional looping.

As mentioned previously, processing all possible permutations in parallel may not be applicable or needed in most practical signal processing scenarios. Regardless, establishing the above analytical relationship for the architecturally comprehensive methodology described in the present disclosure is necessary so that a system for determining which permutations can or should be selected for a given application scenario can be developed.

With the above architecturally-motivated innovations defined and explained, the next challenge and innovation opportunity is to define a mapping mechanism that would lead to compact, latency-reduced and energy-saving chip design or hardware implementation involving the use of GPU, FPGA, etc. Converting the innovations in the present disclosure into hardware implementation related benefits is one of the objectives of the present disclosure.

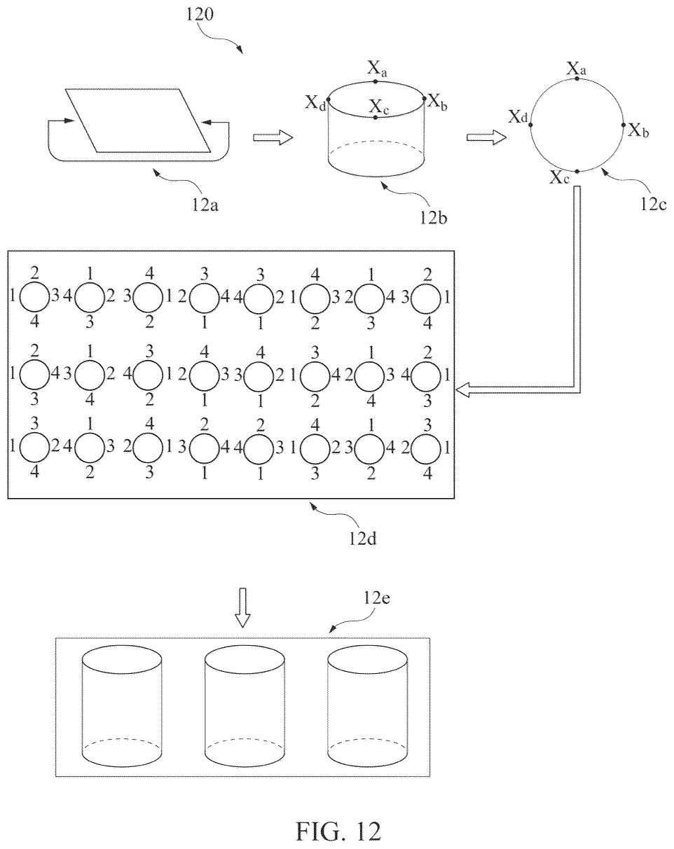

An innovative mapping and compactness-improving process is illustrated as an example 130 shown in FIG. 13. For simplicity of illustration, the process starts with drawing the basic N-inputs-with-2N-outputs architecture 13A as a blank 2-D parallelogram shape 13A of a rolled cylinder 13C. In other words, instead of viewing and treating this basic N-inputs-with-2N-outputs architecture as a hollow cylindrical structure 13C, it is re-drawn as a planar parallelogram similar to FIG. 11. Notably, for hardware implementation, a hollow 3-D cylindrical structure is clearly not desirable nor practical as far as achieving spatial compactness and minimizing processing latency are concerned. In the process of coming up with a computationally efficient as well as a spatially compact hardware implementation, it would mean that (N−1)!/2 (or less depending on the final customized solution) number of planar processing parallelograms can first be lined up in series so as to create a “long sheet of processing parallelograms”, followed by rolling up this long sheet of processing parallelograms. In other words, in order to process these permutations in parallel using an efficient and a compact arrangement involving the use of minimal “integrated circuit real estate”, lining up multiple independent parallelograms in series is done first. This is followed by rolling up this “long sheet” of multiple processing parallelograms into a rolled-up cylindrical structure as illustrated in FIG. 13.

To re-state and further elaborate, FIG. 13 shows the example 130 that represents an innovation for hardware implementation 13A. Treating a N-inputs-with-2N-outputs architecture 13A as a planar parallel processing parallelogram architecture (instead of visualizing it as a 3-D cylindrical structure 13C including multiple hardware implementations 13A), a number of them can be thought of being lined up in series first, i.e., forming a “long sheet of planar parallelogram shapes.” This long sheet of planar parallelogram shapes can then be rolled up into a spatially compact architecture, hence eliminating the problem of having a lot of inner hollow space associated with each individual regular cylindrical processing structure. This has important hardware implementation implications, including the ability and flexibility of minimizing “chip real estate” in the IC chip design process. Using this architecturally comprehensive methodology could also lead to lower energy consumption, reduced processing latency, and so on, relative to any MGS-based approach.

As previously mentioned, the concept of processing all possible permutations associated with a given set of input data vectors may not be computationally practical for many application scenarios currently. On the other hand, it is also clear that advancements and breakthroughs in the high-tech sectors of accelerated computing, AI chip design, quantum computing and so on are taking place at a breathtaking pace.

The final integrated innovation and architectural breakthrough associated with the present disclosure relates to the popular “batch mode processing” application scenario, which is a common and widely used signal processing situation.

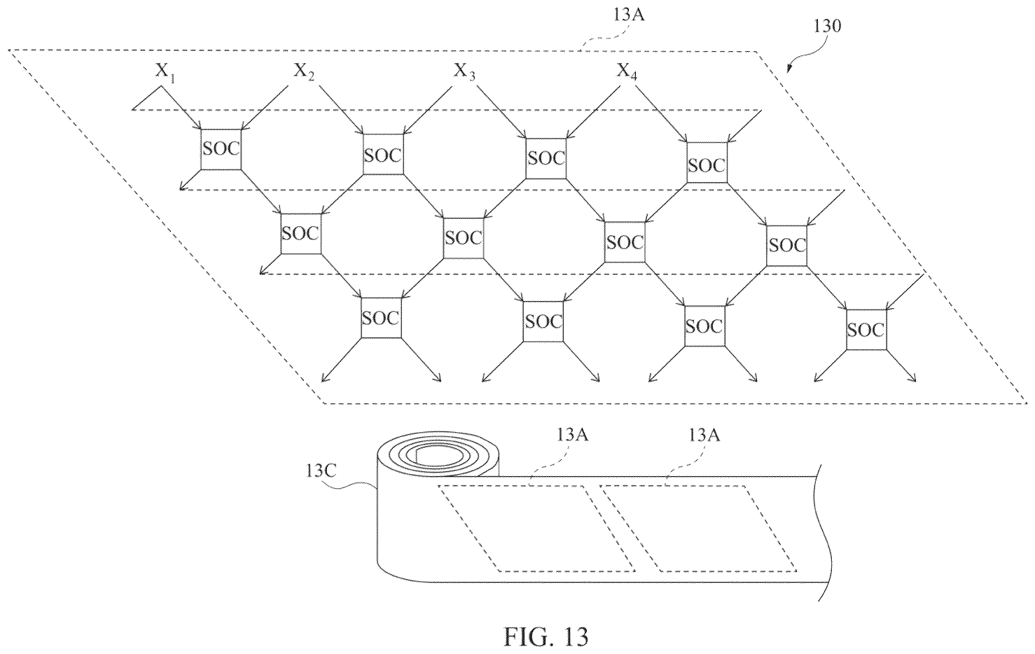

Typically, when processing a given set of input vectors using the N-inputs-with-2N-outputs architecture such as the one shown in FIG. 11 for the case of N=4, a given set of input vectors is first processed by the first row of SOCs (defined in FIG. 2) in the processing architecture, then the output vectors produced by this top row of SOCs would then become the input vectors for the second row of SOCs, and so on. On the other hand, in the so-called “batch mode processing” scenario as defined here, when a given row of SOCs carries out the corresponding computations, all other rows of SOCs are (or could be made) idle, depending on the specific signal processing situation or hardware implementation options involved. Given this computationally idle situation or arrangement associated with this batch-mode processing scenario, the technique of using feedback loops can be deployed to first condense the basic parallelogram to a line-array architecture as shown in FIG. 14. For example, FIG. 14 shows an example 140 that presents an innovation reflecting an ultra compact hardware implementation arrangement 14A for the popular “batch mode processing” scenario. This corresponds to a situation that only one row of SOCs in a repeatable module 14B is computationally active while the remaining rows are, or can be made, idle. In this case, each output vector produced after the first level of orthogonalization on the architecture is fed back as an input vector to a neighboring SOC. Consequently, this feedback loop arrangement condenses the initial architecture to one that contains just one single row of SOCs, In other words, a line array of SOCs would therefore replace an entire N-inputs-with-2N-outputs parallelogram architecture. (Note: Again, a “parallelogram” here can also be visualized as a “cylinder” 14C including multiple repeatable modules 14B if the two opposite edges are connected). Since each N-inputs-with-2N-outputs architecture processes 2N permutations out of a total of N!permutations, it would therefore take N!/2N or (N−1)!/2 independent line arrays of SOCs to cover all possible permutations in this case. Hence instead of rolling up a long sheet of parallelogram architectures as in the case of FIG. 14, rolling up (N−1)!/2 number of end-to-end line arrays is done as shown in FIG. 14. Again, the basic N-inputs-with-2N-outputs parallelogram architecture would become a line-array which can be viewed as just the first row of SOCs of the original N-inputs-with-2N-outputs parallelogram architecture after inserting in all the feedback loops.

As far as the task of processing all or some of the permutations requiring multiple line array architectures, the rolling action is the same as the case of rolling up multiple parallelograms. This is also explicitly shown in FIG. 14. Notably, instead of just using a single row of SOCs and then lining up a number of these single row of SOCs before the rolling action, a set of these single rows of SOCs can also be stacked up first before the rolling. This would then lead to a “thicker” or “taller” rolled-up ring-like structure.

Notably, starting with the basic 2-D triangular parallel processing as shown in FIG. 4 for carrying out QR decomposition that is totally different from the well-established MGS architecture of FIG. 3, various innovations for upgrading or optimizing it into 1-D line-array architectures and 3-D cylindrical architectures for various application scenarios are illustrated throughout the present disclosure. These innovations and architectural breakthroughs can be realized largely due to new insights obtained by re-examining the pros and cons in connection with the seven-decade old MGS algorithm and its corresponding parallel processing architecture, as well as discoveries of certain previously untapped computational symmetry and parallel processing concepts in connection with the fundamental QR decomposition concept.

QR decomposition has been and will remain a powerful Linear Algebra tool for a wide spectrum of applications, especially for the crucial areas of Machine Learning, Signal Processing, the emerging “6G” future, and so forth. The term of “architecturally comprehensive methodology” is strategically and logically chosen as part of the title of the present disclosure to reflect that all the novel ideas and innovations are largely architecturally motivated and driven. Another reason for emphasizing the “comprehensiveness” factor is that the methodology enables the developments of architecturally optimized solutions for a wide range of signal processing and machine learning scenarios, while mathematically adherent to the QR decomposition principle and theory. To the best of the present knowledge, this orthogonalization-driven and architecturally comprehensive methodology (which can be viewed as a well-defined system of intertwined and interlocked architecturally-motivated innovations) represents an original technological milestone. In essence, it integrates processing parallelism, QR decomposition and critical hardware implementation considerations together in a cohesive and mathematically verifiable manner.

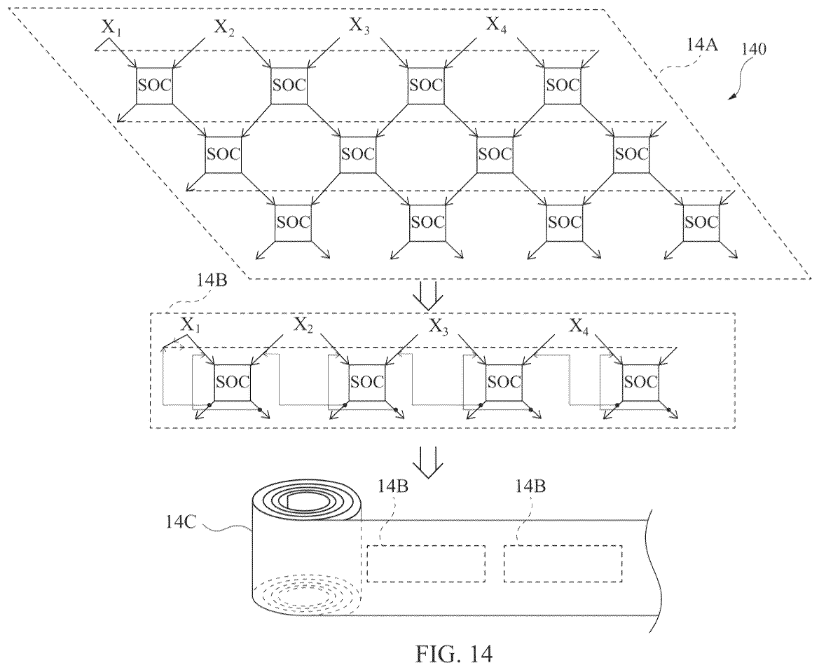

In addition, a suitable computing system can be used for performing the operations for signal processing described above. For example, FIG. 15 depicts an example of a computing device 150 that can implement methods such as computer-implemented methods for the signal processing herein.

In some embodiments, the computing device 150 can include a processor 151 that is coupled to a memory 152 and is configured to execute program instructions stored in the memory 152 to perform the operations for implementing a computer-implemented method associated with the signal processing.

For example, the processor 151 may comprise a microprocessor, an application-specific integrated circuit (“ASIC”), a state machine, or other processing device. The processor 151 can include one or more processing units. Such a processor can include or may be in communication with a computer-readable medium storing instructions that, when executed by the processor 151, cause the processor to perform the operations described herein. The memory 152 can include any suitable non-transitory computer-readable medium.

For example, the computer-readable medium can include any electronic, optical, magnetic, or other storage device capable of providing a processor with computer-readable instructions or other program codes. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer programming language, including, for example, C, C++, C#, Visual Basic, Java, Python, Perl, JavaScript, and ActionScript.

In addition, a suitable non-transitory machine-readable medium can be used for performing the operations for signal processing described above, such as shown in FIGS. 5-6 and 11. For example, a non-transitory machine-readable medium upon which are stored instructions, the instructions when executed by a processor cause the processor to perform steps including providing a model with an N-inputs-with-2N-outputs architecture, in which a plurality of building units are arranged in a plurality of levels, each level has N-numbered building units, each building unit is capable of performing a symmetric orthogonalization in association with two vectors input by two ports on two sides and two vectors output by two ports on two sides, in which two vectors input and output by two ports on the same side of each of the building units are orthogonal, two ports on different sides of adjacent two of the building units or different sides of the first and the last of the building units are capable of inputting one of N-numbered vectors in the first level, the N-numbered building units are capable of outputting one of 2N-numbered vectors in the last level, and in an upper level and a lower level adjacent between the first and last levels, two ports for outputting data on different sides of two adjacent building units or different sides of the first and last building units in the upper level are linked to two ports for inputting data on different sides of one of the building units in the lower level; and retrieving a set of vectors in a linked-ports path from one port of one building unit in the last level to one port of one building unit in the first level in a zigzagging-from-bottom-up manner.

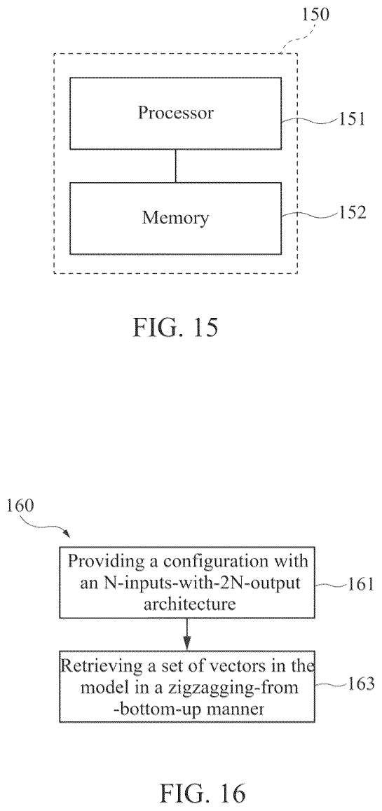

In addition, a suitable method can be used for performing the operations for signal processing described above, such as shown in FIGS. 5-6 and 11. For example, FIG. 16 depicts a method example 160 that can implement methods such as computer-implemented methods for processing signals herein. The method example 160 indicating a computer-implemented method includes steps 161 and 163, in step 161, providing a configuration with an N-inputs-with-2N-outputs architecture, in which a plurality of building units are arranged in a plurality of levels, each level has N-numbered building units, each building unit is capable of performing a symmetric orthogonalization in association with two vectors input by two ports on two sides and two vectors output by two ports on two sides, in which two vectors input and output by two ports on the same side of each of the building units are orthogonal, two ports on different sides of adjacent two of the building units or different sides of the first and the last of the building units are capable of inputting one of N-numbered vectors in the first level, the N-numbered building units are capable of outputting one of 2N-numbered vectors in the last level, and in an upper level and a lower level adjacent between the first and last levels, two ports for outputting data on different sides of two adjacent building units or different sides of the first and last building units in the upper level are linked to two ports for inputting data on different sides of one of the building units in the lower level; in step 163, retrieving a set of vectors in a linked-ports path from one port of one building unit in the last level to one port of one building unit in the first level in a zigzagging-from-bottom-up manner.

Furthermore, a suitable system can be used for performing the operations for signal processing described above, such as shown in FIGS. 5-6 and 11. For example, a system includes a processor coupled to a memory storing instructions executed in the processor, the processor configured to perform operations including: providing a configuration with an N-inputs-with-2N-outputs architecture, in which a plurality of building units are arranged in a plurality of levels, each level has N-numbered building units, each building unit is capable of performing a symmetric orthogonalization in association with two vectors input by two ports on two sides and two vectors output by two ports on two sides, in which two vectors input and output by two ports on the same side of each of the building units are orthogonal, two ports on different sides of adjacent two of the building units or different sides of the first and the last of the building units are capable of inputting one of N-numbered vectors in the first level, the N-numbered building units are capable of outputting one of 2N-numbered vectors in the last level, and in an upper level and a lower level adjacent between the first and last levels, two ports for outputting data on different sides of two adjacent building units or different sides of the first and last building units in the upper level are linked to two ports for inputting data on different sides of one of the building units in the lower level; and retrieving a set of vectors in a linked-ports path from one port of one building unit in the last level to one port of one building unit in the first level in a zigzagging-from-bottom-up manner.

Moreover, a suitable circuit can be used for performing the operations for signal processing described above, such as shown in FIGS. 5-6 and 11. For example, a circuit which is implemented in a chip and includes a sub-circuit with an N-inputs-with-2N-outputs architecture, in which a plurality of building units are arranged in a plurality of levels, each level has N-numbered building units, each building unit is capable of performing a symmetric orthogonalization in association with two vectors input by two ports on two sides and two vectors output by two ports on two sides, in which two vectors input and output by two ports on the same side of each of the building units are orthogonal, two ports on different sides of adjacent two of the building units or different sides of the first and the last of the building units are capable of inputting one of N-numbered vectors in the first level, the N-numbered building units are capable of outputting one of 2N-numbered vectors in the last level, and in an upper level and a lower level adjacent between the first and last levels, two ports for outputting data on different sides of two adjacent building units or different sides of the first and last building units in the upper level are linked to two ports for inputting data on different sides of one of the building units in the lower level; and a logic portion is configured to retrieve a set of vectors in a linked-ports path from one port of one building unit in the last level to one port of one building unit in the first level in a zigzagging-from-bottom-up manner.

In some embodiment, the retrieving the set of vectors in the linked-ports path from one port of one building unit in the last level to one port of one building unit in the first level in the zigzagging-from-bottom-up manner includes: setting one port of one of the building units in the last level to be a target port; and recursively performing a process until the target port is the port for inputting data in the first level, the process including: in response to determining the target port being the port for outputting data, setting the vector at the target port to be one of the set of vectors, and setting the port for inputting data on the same side as the target port of the same building unit to update the target port; in response to determining the target port being the port for inputting data and not in the first level, setting the port for outputting data linked to the target port to update the target port; and in response to determining the target port being the port for inputting data in the first level, setting the vector at the target port to be one of the set of vectors.

In some embodiment, the N-numbered building units in each level input data in a circular manner; the building unit in the configuration are rolled-up in a cylindrical structure; the cylindrical structure is made in a three-dimensional integrated circuit.

Although the present invention has been disclosed in preferred embodiments, they are not intended to limit the present disclosure. Any person skilled in the art can make various changes and modifications without departing from the spirit and scope of the present disclosure. Therefore, the protection scope of the present disclosure shall be determined by the appended patent application scope.

What is claimed is:

1. A computer-implemented method, comprising:
providing a configuration with an N-inputs-with-2N-outputs architecture, in which a plurality of building units are arranged in a plurality of levels, each level has N-numbered building units, each building unit is capable of performing a symmetric orthogonalization in association with two vectors input by two ports on two sides and two vectors output by two ports on two sides, in which two vectors input and output by two ports on the same side of each of the building units are orthogonal, two ports on different sides of adjacent two of the building units or different sides of the first and the last of the building units are capable of inputting one of N-numbered vectors in the first level, the N-numbered building units are capable of outputting one of 2N-numbered vectors in the last level, and in an upper level and a lower level adjacent between the first and last levels, two ports for outputting data on different sides of two adjacent building units or different sides of the first and last building units in the upper level are linked to two ports for inputting data on different sides of one of the building units in the lower level; and
retrieving a set of vectors in a linked-ports path from one port of one building unit in the last level to one port of one building unit in the first level in a zigzagging-from-bottom-up manner.

2. The computer-implemented method as claimed in claim 1, wherein the retrieving the set of vectors in the linked-ports path from one port of one building unit in the last level to one port of one building unit in the first level in the zigzagging-from-bottom-up manner comprises:
setting one port of one of the building units in the last level to be a target port; and
recursively performing a process until the target port is the port for inputting data in the first level, the process comprising:
in response to determining the target port being the port for outputting data, setting the vector at the target port to be one of the set of vectors, and setting the port for inputting data on the same side as the target port of the same building unit to update the target port;
in response to determining the target port being the port for inputting data and not in the first level, setting the port for outputting data linked to the target port to update the target port; and
in response to determining the target port being the port for inputting data in the first level, setting the vector at the target port to be one of the set of vectors.

3. The computer-implemented method as claimed in claim 1, wherein the N-numbered building units in each level input data in a circular manner.

4. The computer-implemented method as claimed in claim 1, wherein the building units in the configuration are rolled-up in a cylindrical structure.

5. The computer-implemented method as claimed in claim 4, wherein the cylindrical structure is made in a three-dimensional integrated circuit.

6. A system comprising a processor coupled to a memory storing instructions executed in the processor, the processor configured to perform operations comprising:
providing a configuration with an N-inputs-with-2N-outputs architecture, in which a plurality of building units are arranged in a plurality of levels, each level has N-numbered building units, each building unit is capable of performing a symmetric orthogonalization in association with two vectors input by two ports on two sides and two vectors output by two ports on two sides, in which two vectors input and output by two ports on the same side of each of the building units are orthogonal, two ports on different sides of adjacent two of the building units or different sides of the first and the last of the building units are capable of inputting one of N-numbered vectors in the first level, the N-numbered building units are capable of outputting one of 2N-numbered vectors in the last level, and in an upper level and a lower level adjacent between the first and last levels, two ports for outputting data on different sides of two adjacent building units or different sides of the first and last building units in the upper level are linked to two ports for inputting data on different sides of one of the building units in the lower level; and
retrieving a set of vectors in a linked-ports path from one port of one building unit in the last level to one port of one building unit in the first level in a zigzagging-from-bottom-up manner.

7. The system as claimed in claim 6, wherein the retrieving the set of vectors in the linked-ports path from one port of one building unit in the last level to one port of one building unit in the first level in the zigzagging-from-bottom-up manner comprises:
setting one port of one of the building units in the last level to be a target port; and
recursively performing a process until the target port is the port for inputting data in the first level, the process comprising:
in response to determining the target port being the port for outputting data, setting the vector at the target port to be one of the set of vectors, and setting the port for inputting data on the same side as the target port of the same building unit to update the target port;
in response to determining the target port being the port for inputting data and not in the first level, setting the port for outputting data linked to the target port to update the target port; and
in response to determining the target port being the port for inputting data in the first level, setting the vector at the target port to be one of the set of vectors.

8. The system as claimed in claim 6, wherein the N-numbered building units in each level input data in a circular manner.

9. The system as claimed in claim 5, wherein the building units in the configuration are rolled-up in a cylindrical structure.

10. The system as claimed in claim 5, wherein the cylindrical structure is made in a three-dimensional integrated circuit.

11. A circuit, implemented in a chip, comprising:
a sub-circuit with an N-inputs-with-2N-outputs architecture, in which a plurality of building units are arranged in a plurality of levels, each level has N-numbered building units, each building unit is capable of performing a symmetric orthogonalization in association with two vectors input by two ports on two sides and two vectors output by two ports on two sides, in which two vectors input and output by two ports on the same side of each of the building units are orthogonal, two ports on different sides of adjacent two of the building units or different sides of the first and the last of the building units are capable of inputting one of N-numbered vectors in the first level, the N-numbered building units are capable of outputting one of 2N-numbered vectors in the last level, and in an upper level and a lower level adjacent between the first and last levels, two ports for outputting data on different sides of two adjacent building units or different sides of the first and last building units in the upper level are linked to two ports for inputting data on different sides of one of the building units in the lower level; and
a logic portion is configured to retrieve a set of vectors in a linked-ports path from one port of one building unit in the last level to one port of one building unit in the first level in a zigzagging-from-bottom-up manner.

12. The circuit as claimed in claim 11, wherein the logic portion is further configured to:
set one port of one of the building units in the last level to be a target port; and
recursively perform a process until the target port is the port for inputting data in the first level, the process comprising:
in response to determining the target port being the port for outputting data, setting the vector at the target port to be one of the set of vectors, and setting the port for inputting data on the same side as the target port of the same building unit to update the target port;
in response to determining the target port being the port for inputting data and not in the first level, setting the port for outputting data linked to the target port to update the target port; and
in response to determining the target port being the port for inputting data in the first level, setting the vector at the target port to be one of the set of vectors.

13. The circuit as claimed in claim 11, wherein the N-numbered building units in each level input data in a circular manner.

14. The circuit as claimed in claim 11, wherein the building unit in the configuration are rolled-up in a cylindrical structure.

15. The circuit as claimed in claim 14, wherein the cylindrical structure is made in a three-dimensional integrated circuit.

16. A non-transitory machine-readable medium upon which are stored instructions, the instructions when executed by a processor cause the processor to perform steps comprising:
providing a model with an N-inputs-with-2N-outputs architecture, in which a plurality of building units are arranged in a plurality of levels, each level has N-numbered building units, each building unit is capable of performing a symmetric orthogonalization in association with two vectors input by two ports on two sides and two vectors output by two ports on two sides, in which two vectors input and output by two ports on the same side of each of the building units are orthogonal, two ports on different sides of adjacent two of the building units or different sides of the first and the last of the building units are capable of inputting one of N-numbered vectors in the first level, the N-numbered building units are capable of outputting one of 2N-numbered vectors in the last level, and in an upper level and a lower level adjacent between the first and last levels, two ports for outputting data on different sides of two adjacent building units or different sides of the first and last building units in the upper level are linked to two ports for inputting data on different sides of one of the building units in the lower level; and
retrieving a set of vectors in a linked-ports path from one port of one building unit in the last level to one port of one building unit in the first level in a zigzagging-from-bottom-up manner.

17. The non-transitory machine-readable medium as claimed in claim 16, wherein the processor, upon executing the stored instructions, is further configured to perform steps comprising:
setting one port of one of the building units in the last level to be a target port; and
recursively performing a process until the target port is the port for inputting data in the first level, the process comprising:
in response to determining the target port being the port for outputting data, setting the vector at the target port to be one of the set of vectors, and setting the port for inputting data on the same side as the target port of the same building unit to update the target port;
in response to determining the target port being the port for inputting data and not in the first level, setting the port for outputting data linked to the target port to update the target port; and
in response to determining the target port being the port for inputting data in the first level, setting the vector at the target port to be one of the set of vectors.

18. The non-transitory machine-readable medium as claimed in claim 16, wherein the N-numbered building units in each level input data in a circular manner.
